(19) United States
(12) Patent Application Publication
(10) Pub. No.: US 2023/0291051 A1
(43) Pub. Date: Sep. 14, 2023

(54) BATTERY HOLDER AND BATTERY HOLDER ARRANGEMENT FOR A LIGHT ELECTRIC VEHICLE

(71) Applicant: REVONTE OY, Tampere (FI)

(72) Inventors: Jan KLEIN, Tampere (FI); Jere KOSKINEN, Tampere (FI)

(21) Appl. No.: 18/013,957

(22) PCT Filed: Jul. 2, 2021
(86) PCT No.: PCT/FI2021/050513

§ 371 Date: Dec. 30, 2022

(30) Foreign Application Priority Data
Jul. 3, 2020 (FI) 20205719

(51) Int. Cl. H01M 50/249; B62M 6/90

(52) U.S. Cl. CPC H01M 50/249; B62M 6/90; H01M 2220/20

(57) ABSTRACT

The present invention discloses a battery holder for a light electric vehicle (1). Battery holder (30) comprises a fixed end (80) and a moving end (84). The fixed end (80) comprises at least one pivot surface (81) arranged to provide a pivot to the battery (20) during the insertion and detachment of the battery (20). The moving end (84) comprises a latch support (101), a locking unit (150) and a latch (108). The latch (108) comprises an axle (102), and an arm (110) arranged to rotate around the axle (102), and an extender (120) arranged to extend and contract the latch (108) telescopically in relation to the arm (110). The extender 120 comprises a latch tongue (130) arranged to hold the battery (20). The latch (108) also comprises a force unit (123) and a torsion unit (103).

The present invention relates to a battery holder for a light electric vehicle, and more particularly to a battery holder according to preamble of claim 1. The present invention also relates to a battery holder arrangement, and more particularly to a battery holder arrangement according to preamble of claim 13.

### BACKGROUND OF THE INVENTION

Electric vehicles, in particular light electric vehicles like electric bicycles, e-bikes or electric motorcycles are getting more and more popular among consumers and vehicle sharing systems. All light electric vehicles share many preferable qualities. They are light weight, have virtually no exhausts and very low noise emissions and are yet able to move persons at feasible speeds and distances. Light electric vehicles come in various forms, some having only a small electric motor to assist the rider's pedaling (e.g. a pedelec), some having three or four wheels and having just an electric motor for propulsion.

Common features to all light electric vehicle are as follows: they all have either an assisting or a main electric motor to move the vehicle, and to energize the motor, they all must have access to a portable form of energy usable in an electric motor. This practically means that the vehicles must carry a battery that stores electric energy in form of electric charge at a certain voltage level. Also fuel cell technologies are emerging for this purpose, but their widespread adoption in the industry is still mostly in the future.

Batteries for light electric vehicles must meet various requirements. To facilitate charging, they are preferably detachable from the vehicle as vehicles are often stored in places with no electric outlets. Instead, it is often easier to take just the battery inside and charge it with a charger and leave the vehicle outside. This imposes various needs for the weight, size and shape of the battery, and also to the ways the battery is inserted to, held in and detached from the vehicle. If it is difficult or cumbersome to operate the battery in and out of the vehicle or the battery is not held firmly enough, user experience suffers and in the worst case the vehicle is rendered unusable.

For the light electric vehicle industry, shape, size and form of the battery are important factors as also the vehicles come in different shapes, forms and sizes. Often it is advantageous to place the battery inside the frame of the vehicle to safeguard it from environmental effects like water, dirt, wear and impacts. Space available for the battery inside the frame is naturally determined mostly by the outer design of the frame. This, in turn, is mostly determined by aesthetic, mechanical and aerodynamic considerations. To be widely usable, a battery is preferably a longitudinal volume and having a longitudinal cross section e.g. of a rounded rectangle with different height and width dimensions to suit vehicle frames having a “thick and short” or a “thin and tall” cross section. Ideally, a same battery would fit in as many in-frame installations as possible with only minimal modifications. The same is true also for battery attachments outside the frame where space is also limited to maintain a streamlined and aerodynamic shape for the vehicle's configuration. Further, even when the shape of the battery changes, it is beneficial to be able to use the same battery holder as making different battery holders for different types of batteries makes the manufacture and logistics of the vehicles more challenging.

In the prior art, a major problem in using detachable batteries in light electric vehicles is the following: How to insert and detach the battery both mechanically and electrically in a robust way into the frame of the bike and couple it with energy consuming components like the electric motor firmly and easily. Preferably, the insertion and detachment of the battery could be managed with one hand as the operator of the vehicle often has to lean and get support from the frame of the vehicle with the other hand. Of course, all the connections of the battery, mechanical and electric, should happen as simply as possible. Ideally, the electric connection would be self-mating during the insertion of the battery, and self-disconnecting when the battery is detached. The battery holder should also be operable in different orientations and hold the battery firmly in any direction or orientation as the battery holder can be arranged in various positions in or on the vehicle. Batteries are heavy and expensive and need safeguarding against mechanical shaking and theft and these factors impose problems for the prior art, too.

In prior art, often insertion of the battery takes both hands and requires complex interactions, especially if the battery needs to be locked with a locking mechanism. The holding of the battery is not very firm in the prior art. It is difficult to adapt the locking mechanism to batteries of various shapes and sizes.

Thus, there is a need to improve the mechanisms known from the prior art related to the ways the battery is operated with during insertion, holding and detachment.

### BRIEF DESCRIPTION OF THE INVENTION

An object of the present invention is to provide a battery holder for light electric vehicles so that the prior art disadvantages are solved or at least alleviated. The objects of the invention are achieved by a battery according to the independent claim 1. The objects of the invention are further achieved by a battery holder arrangement according to the independent claim 13.

The preferred embodiments of the invention are disclosed in the dependent claims.

As an aspect of the invention, a battery holder for a light electric vehicle is disclosed. The battery holder for a light electric vehicle comprises a fixed end and a moving end. The fixed end comprises at least one pivot surface arranged to provide a pivot to the battery during insertion and detachment of the battery. The moving end comprises a latch support, a locking unit and a latch. The latch comprises an axle, and an arm arranged to rotate around the axle, and an extender arranged to extend and contract the latch telescopically in relation to the arm.

As a further aspect of the invention, a battery holder for a light electric vehicle is also disclosed. The battery holder comprises a fixed end and a moving end, the fixed end comprising at least one pivot surface arranged to provide a pivot to a battery during insertion and detachment of the battery. The moving end comprises a latch support, a locking unit and a latch. The latch comprises an axle, and an arm arranged to rotate around the axle, and an extender arranged to extend and contract the latch telescopically in relation to the arm. The extender comprises a latch tongue arranged to hold the battery. The latch comprises a force unit arranged between the arm and the extender. The force unit is arranged to provide force to extend the extender from the arm. The latch also comprises a torsion unit arranged between the arm and the latch support. The torsion unit is arranged to provide torsion to the arm to rotate the arm around the axle towards the fixed end.

As an embodiment, the latch comprises a force unit arranged between the arm and the extender. The force unit is arranged to provide force to extend the extender from the arm. The latch also comprises a torsion unit arranged between the arm and the latch support. The torsion unit is arranged to provide torsion to the arm to rotate the arm around the axle towards the fixed end.

According to an embodiment, the force unit comprises a compression spring, a tension spring, an elastic band, a hydraulic unit, a pneumatic unit, or any combination thereof.

According to another embodiment, the torsion unit comprises a torsion spring, a compression spring, a tension spring, an elastic band, a hydraulic unit, a pneumatic unit, or any combination thereof.

According to yet another embodiment, the extender comprises a latch tongue arranged to hold the battery.

According to an embodiment, the latch tongue comprises a distal chamfer arranged to provide torsion to the latch turning the latch away from the fixed end when the battery comes into contact with the latch during the insertion of the battery, or a proximal chamfer arranged to provide torsion to the latch turning the latch away from the fixed end when the battery is being detached from the battery holder, or both a distal chamfer arranged to provide torsion to the latch turning the latch away from the fixed end when the battery comes into contact with the latch during the insertion of the battery, and a proximal chamfer arranged to provide torsion to the latch turning the latch away from the fixed end when the battery is being detached from the battery holder.

In other words, the torsion provided by the distal chamfer, the proximal chamfer, or both the distal chamfer and the proximal chamfer to the latch turns the latch away from the fixed end.

As an embodiment, the latch support comprises one or more rotation stoppers that are arranged to limit the angle of rotation of the latch towards the fixed end.

According to another embodiment, the extender comprises a locking notch and the locking unit comprises a locking tongue having a locked position where the locking tongue is in the locking notch of the extender of the latch to hold the latch in a locked position, and an unlocked position where the locking tongue is outside the locking notch of the extender of the latch.

According to an embodiment, the locking unit comprises a lock operable with a key, a bolt or a clamp.

As an embodiment, the extender is arranged to extend and contract telescopically in relation to the arm guided by at least one guiding groove and at least one guiding pin, or the inner shape of the arm and the matching outer shape of the extender, or the outer shape of the arm and the matching inner shape of the extender, or at least one guiding groove and at least one guiding pin, and the inner shape of the arm and the matching outer shape of the extender, or at least one guiding groove and at least one guiding pin, and the outer shape of the arm and the matching inner shape of the extender.

According to an embodiment, the battery holder further comprises a connecting element arranged to connect the fixed end and the moving end, the connecting element comprises a rail or a narrow sheet to which the fixed end or the moving end or both are affixed, or a portion of the frame of the light electrical vehicle.

As an embodiment, when the insertion of the battery commences, the latch is arranged to be in a pre-insertion state in which the extender is pushed to a position of maximum free extension by the force unit and the arm is pushed to a position of maximum rotation by the torsion unit limited by the one or more rotation stoppers.

According to another embodiment, when the locking unit becomes unlocked with the battery in an attached state in the battery holder, the force unit is arranged to push the extender to a distance of maximum loaded extension, whereby the battery rotates about the pivot surface by a force exerted to the battery with the latch tongue of the extender, and after the rotation, the latch tongue is arranged to hold the battery in a pre-release state by torsion of the torsion unit of the latch.

According to yet another embodiment, the torsion unit is arranged to generate torsion of magnitude that maintains the pre-release state and holds the battery when the battery rotates downwards from the attached state to the pre-release state.

In an aspect of the present invention, the battery holder of the battery holder arrangement is a battery holder according to the invention and its embodiments, the battery holder arrangement comprises a battery, battery comprising a first end cap, the first end cap comprising at least one notch into which at least one pivot surface of the battery holder fits, and the battery rotates around the at least one pivot surface during insertion of the battery to the battery holder, and during detachment of the battery from the battery holder.

For the purposes of this text, “torsion” is a force that can cause an object to rotate about an axis.

For the purposes of this text, “during” an event X, for example “during insertion” means one or more periods of time within the event X such that the one or more periods of time do not have to span the entire duration of the event X. In other words, “during X” means “at one or more periods of time in the course of X”.

The invention is based on the idea of providing a battery holder with a fixed end and a moving end. The fixed end is provided with a pivot surface that supports and pivots the battery during the insertion and the detachment of the battery. Further, the moving end comprises a latch support and a latch. Latch comprises an arm arranged to rotate around an axle, and an extender arranged to extend and contract telescopically in relation to the arm.

An advantage of the invention is that as the latch of the battery holder is arranged to rotate, extend and contract and at the same time hold one of the ends of the battery, the battery holder can also move one of the ends of the battery along. Thus, various states for the battery can be provided during insertion and during detachment so that the battery can be inserted and detached using one hand only with simple interactions. Still, a very firm holding of the battery is achieved with a battery holder according to the present invention. By providing the battery with suitable attachment points (e.g. notches and grooves in the ends of the battery) in two orientations, the battery can also be operated in two orientations with minimal or no changes to the battery holder.

### BRIEF DESCRIPTION OF THE DRAWINGS

The invention is described in detail by means of specific embodiments with reference to the enclosed drawings, in which

FIG. 1a shows an example of a prior art light electric vehicle,

FIG. 1b shows two examples of positioning of the battery inside of a frame of a light electric vehicle,

FIG. 2 shows the concept of directions and dimensions of the cross section used in the present application,

FIGS. 3a and 3b show a prior art battery and a general prior art battery connection arrangement,

FIG. 4a shows both ends of the battery holder according to an embodiment of the present invention,

FIG. 4b shows an example of the insertion of a battery into an embodiment of a battery holder according to the invention,

FIG. 5 shows the moving end of a battery holder according to an embodiment of the invention when the insertion of the battery commences,

FIG. 6 shows the moving end of a battery holder according to an embodiment of the invention approximately half-way during the insertion process,

FIG. 7 shows the moving end of a battery holder according to an embodiment of the invention when the battery is inserted and the battery holder (its moving end) is locked,

FIG. 8 shows the moving end of a battery holder according to an embodiment of the invention during a detachment process, and

FIG. 9 shows the moving end of a battery holder according to an embodiment of the invention at the end of the detachment process.

### DETAILED DESCRIPTION OF THE INVENTION

In the following description, like numbers (e.g. 12) or labels (e.g. 80a) denote like elements.

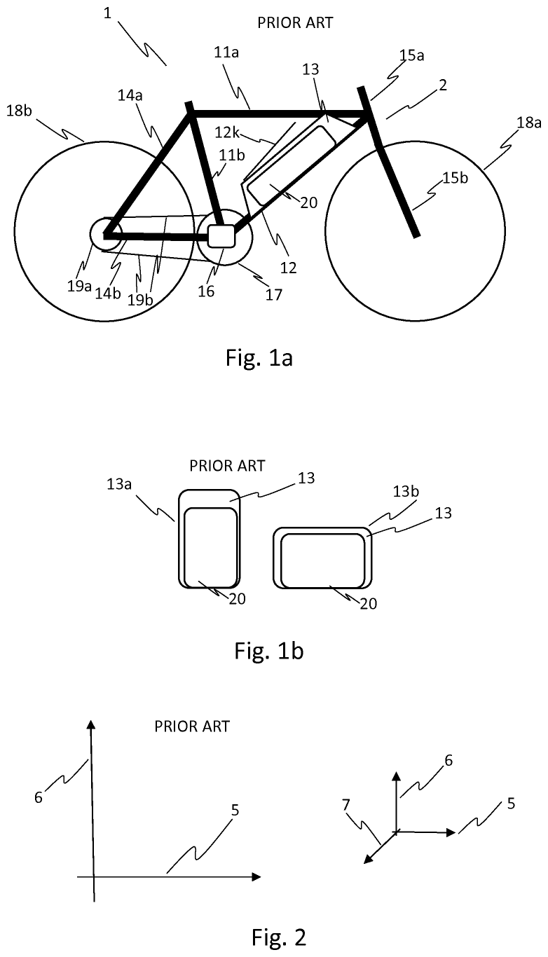

FIG. 1a shows an example of a prior art light electric vehicle, in this case a pedelec or an e-bike 1. Such vehicles are usually built around a frame 2, shown in FIG. 1a with thick black lines and comprising usually mostly tubular elements. In FIG. 1a, there is a top tube 11a, a seat tube 11b, a down tube 12, seat stays 14a and chain stays 14b. Stays 14a and 14b surround the rear wheel 18b of the bike from two sides. In the front, there is a head tube 15a and a fork 15b to suspend the front wheel 18a.

Electric motor 16 assists the pedaling of the bike, coupling torsion to the chain wheel 17 along with the pedals of the bike (not shown). Torsion of the motor and pedaling is coupled to the transmission 19a of the rear wheel 18b with a chain 19b to propel the vehicle. Electric motor can also be arranged e.g. into the center or hub of the rear wheel 18b or even to the front wheel 18a.

Battery 20 resides in a battery compartment 13, accessible with a lid or a cover 12k that can be opened or closed and to protect the battery compartment 13 from the ingress of most of the dirt, dust, water etc. The battery compartment 13 forms a section of the inside of the down tube 12 and all the horizontal and vertical sides of the battery compartment 13 form a weight carrying structure of the frame of the pedelec 1. Thus, in this configuration, the down tube is considerably thicker (dimension in the horizontal direction when the bike is held in a normal riding position) and taller (dimension in the vertical direction, again when the bike is held in an upright riding position) than the rest of the tubes or stays of the frame.

Naturally, the down tube 12 is only an example of a location for a battery compartment 13. The battery compartment may be arranged into or on any other tube or stay of the vehicle, like the top tube 11a or the seat tube 11b as long as relevant standards, mechanical design considerations and vehicle operation permit.

In FIG. 1a, an e-bike 1 is shown as only one example of electric vehicles. Other electric vehicles include electric scooters, electric motorbikes, electric kick scooters, electric skateboards, electric unicycles or electric vehicles with more than two wheels. The term “light” in the concept of “light electrical vehicles” has no standardized meaning. The present invention is advantageous in all electric vehicles where the insertion and removal of the battery is frequent in the daily use of the vehicle in contrast to e.g. an e-car where the batteries are fixed into the car structures and are charged e.g. through a socket at a side of the car, connected to a charging station with a cable.

FIG. 1b shows two prior art orientations in a cross sectional view of battery 20 in a frame or other battery holder of the vehicle. In a thin and tall orientation 13a, the long side of the battery 20 is in the second direction. In a thick and short orientation 13b, the long side of the battery 20 is in the first direction. The longest dimension of the battery 20 is usually in the third dimension or direction. A problem in the prior art is that convenient insertion and detachment and firm holding of the battery 20 into and from the battery compartment 13 in two different orientations is not easy.

FIG. 2 shows orientations of the directions and dimensions that are used in the present application. Arrow 5 indicates the so-called first dimension or first direction, and arrow 6 the second dimension or second direction. It is evident that the dimensions are orthogonally or perpendicularly positioned relative to one another. The coordinate system in FIG. 2 can be rotated along any axis so that arrow 6, as an example, points to the “left” and arrow 5 “up”. In addition, there is also a third dimension to/from the plane spanned by the two arrows 5 and 6, also called the depth dimension or depth direction in the present application. This is show as dimension or direction 7 in FIG. 2. As the batteries are positioned in various ways and orientations in electric vehicles, description of the invention is best done with such relative (first, second and third) dimensions instead of standard frames of reference like horizontal and vertical dimensions.

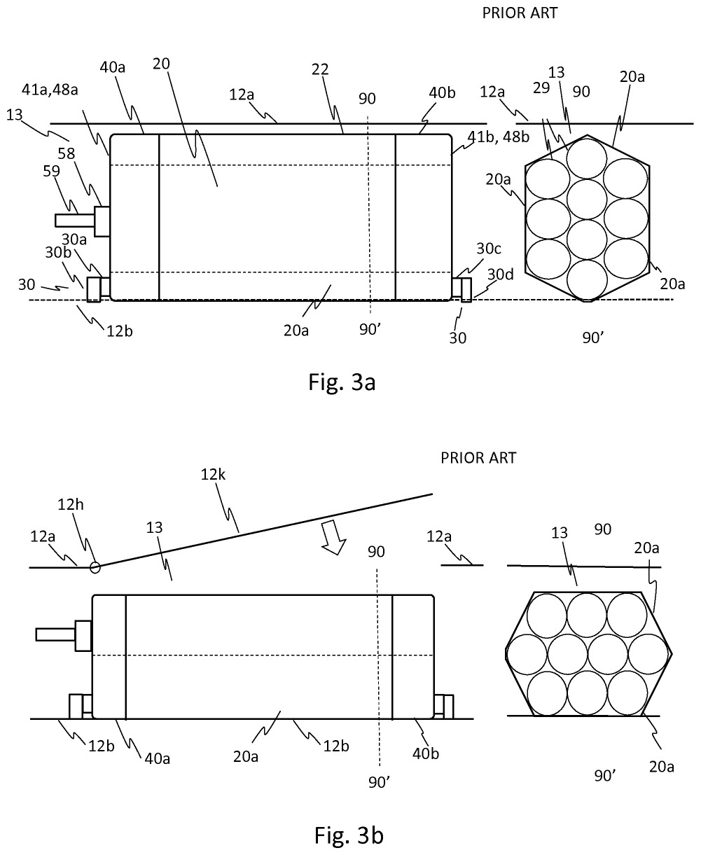

FIG. 3a shows a prior art representation of battery compartment 13, battery 20 and schematic blocks for mechanical and electric connectors 30a-30b and 58-59, respectively.

The battery is held in place mechanically with connectors 30a, 30c and 30b, 30d at both ends 48a and 48b of the battery. The ease of attachment and detachment, and the firmness of the holding of the battery depends considerably on the design of the units 30a and 30c (which are part of the detachable battery) and 30b and 30d (which are permanently affixed to the vehicle). In FIG. 3a, parts affixed to the vehicle (30b, 30d) are jointly denoted as unit 30, the battery holder, which may also comprise other parts like electric connectors etc.

To enable the coupling of electric energy from the battery to the motor and other energy consuming parts of the vehicle, a combination of electric connectors 58 and 59 are provided at battery and vehicle side, respectively. Preferably, the connection and mating of connectors 58 and 59 (unit 59 is also called the electric socket 59) happens simultaneously and by the same motion of the battery with the connection of units 30a-30d. Of course, a separate cabling and a separate connection of connectors 58 and 59 can also be arranged. As the battery carries a considerable energy, it is important to have a good quality electric connection with virtually no chance of short circuiting the battery during insertion, holding or detachment. Similarly, as the battery can weight several kilograms, the mechanical connection needs to be quite robust.

FIG. 3a shows the battery in two different projections, as a side view and as a cutting plane 90-90′. The cutting plane shows that the battery usually comprises several separate battery cells 29. By connecting the cells 29 in series and in parallel appropriately and then providing a connection of the cells to the connector 58, a suitable charging capacity and voltage level can be provided based on elementary electrical engineering concepts.

FIG. 3a illustrates further that a battery 20 comprises further, at both ends, end caps 40a and 40b that provide the first and second ends to the battery 20, respectively. Advantageously, the end caps comprise mechanical and/or electric connectors and other fixing points. This enables keeping the battery frame 20a relatively simple. Battery frame 20a can be e.g. a rectangular parallelepiped with thin metal sheets arranged as the four sides, with a rectangular or rounded rectangular cross section, and with fixing points for the end caps (e.g. screw threads at the first and second ends of the rectangular parallelepiped). Battery frame 20a is preferably made with extrusion of some suitably rigid material, e.g. metal or organic material like rigid plastics.

FIG. 3a also shows how the battery 20 is preferably supported by one side of the battery compartment by a support surface 12b. This surface can be, in the normal operating orientation of the vehicle, below or above the battery, or to any other direction relative to the battery 20. The support surface 12b can support only part of the battery, e.g. the end caps 40a and/or 40b. If the battery 20 can touch a support surface 12b during holding, in other words, rest on it, the holding of the battery 20 is mechanically more robust. Otherwise the entire mass of the battery is only supported by the mechanical connectors 30a-30d at both ends of the battery 20. With suitably robust mechanical connectors 30a-30d, support for the battery can, however, be arranged through the mechanical connectors only 30a-30d, and the battery does not need to touch the support surface 12b when held in the battery holder 30.

In FIG. 3a, the battery is inserted in a “vertical” orientation as the long side of the battery points in a vertical direction relative to the viewer. Naturally, the installation orientation of the battery 20 can be arranged to any direction and in or on the different tubes or stays of the frame 2 of vehicle 1 in FIG. 1a as long as relevant standards, mechanical design considerations and vehicle operation permit.

Also related to prior art, FIG. 3b shows that the battery can be installed also in a horizontal orientation (relative to the operation of the vehicle) where the long side of the battery's longitudinal (the longest dimension of the battery) cross section is oriented horizontally. In FIG. 3b, there is also a lid 12k supported e.g. by a hinge 12h. Lid 12k can also be a cover (e.g. a plate) that has some connection mechanism to the battery compartment 13. Through the opening closed by the lid, the battery can be inserted and detached from the battery compartment 13. Cover also safeguards the battery 20 from dirt, moisture and impacts, which is important to prolong the service life of the battery 20 and its connectors 30a, 30c and 58.

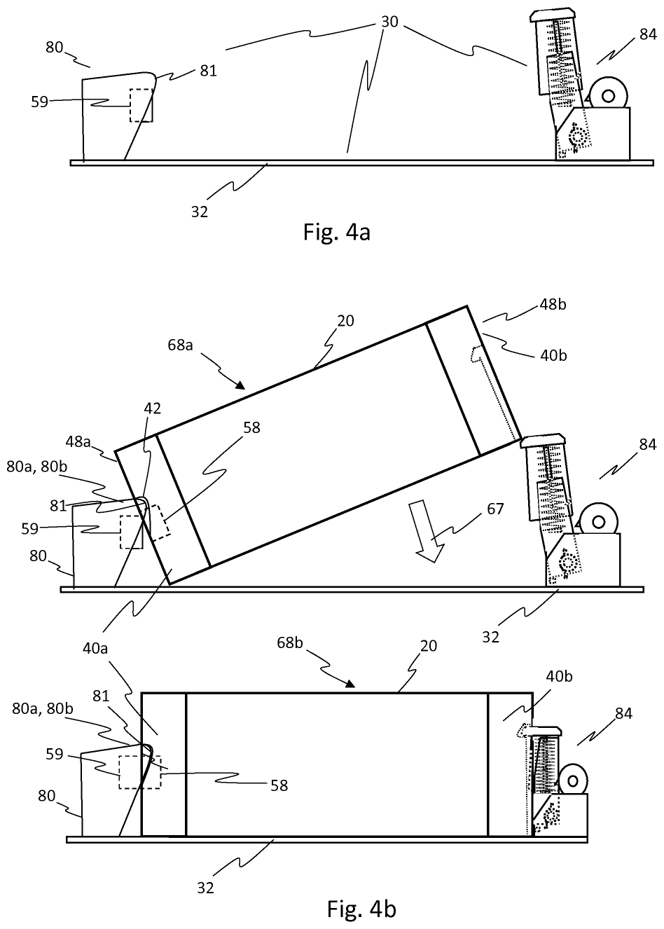

FIG. 4a shows a battery holder 30 according to an aspect of the invention. Battery holder 30 comprises a fixed end 80 (or fixed coupler 80) and a moving end 84 (or moving coupler 84). The fixed end 80 and the moving end 84 may be held at suitably positioned relative to each other with a connecting element 32. In FIG. 4a, the moving end 84 is in the open state waiting for the battery to be inserted. The battery holder 30 further comprises an electric socket 59 for proving electric connection 58 to the battery, and a pivot surface 81 against which the battery can rotate when inserted and detached from the battery holder 30.

As shown in FIG. 4a, the fixed end 80 and the moving end 84 are at the opposite ends of the battery holder 30.

As also shown in FIG. 4a, the first end 48a of the battery 20, and the second end 48b of the battery 20 are at the opposite ends of the battery 20.

FIG. 4b shows an embodiment of the invention, two states of the insertion of the battery 20 where the battery 20 is in two different positions. In step 68a, the battery 20 is just coming into contact with the moving end 84. In step 68a, the battery 20 is already supported by the fixed end 80, by the pivot surface 81 in a notch 42 in the first end cap 40a of the battery 20, at the first end 48a of the battery 20. FIG. 4b shows also the electric connector 58 of the battery 20 which is about to mate to the electric socket 59 of the fixed end.

In the second step 68b of FIG. 4b, the battery 20 is attached and locked into the battery holder 30. Holding of the battery 20 is facilitated at both ends. The fixed end 80 holds the battery 20 with one or more protrusions (also called wings) 80a, 80b. Only one protrusion 80a is shown, but there are many, usually at least two, and in the case of FIG. 4b there are two protrusions, other protrusion 80b being behind the first protrusion 80a. When held in place, the protrusion 80a is at least partially inside a notch 42 in the first end face of the battery 20, in the first end cap 40a. In the fixed end, the electric connector 58 of the battery and electric socket 59 of the fixed end have also mated, providing an electric connection from the battery 20 to the energy consuming components of the vehicle like the electric motor (motor and vehicle not as such shown in FIG. 4b).

In the second step 68b, the moving end 84 holds the battery stationary by taking hold of a notch in a notched groove at the second end face of the battery, in the grooved end cap 40b. The moving end 84 is in a locked position in step 68b, and it has moved (rotated and changed in dimensions) in relation to step 68a. As in FIG. 4a, in FIG. 4b the connecting element 32 holds the position of the fixed end 80 and moving end 84 properly to make a suitable distance and orientation of the fixed end 80 and moving end 84 to fit the battery 20 between them.

Even though FIGS. 4a and 4b show the insertion of the battery 20 so that the grooved end cap 40b moves downwards when inserted (from the topside), the battery holder 30 is arranged to receive the battery 20 also from bottom side so that the grooved end cap 40b moves upwards when inserted. When the vehicle is held in a normal operating and driving position, downwards is the direction towards the ground and upwards is the direction away from the ground.

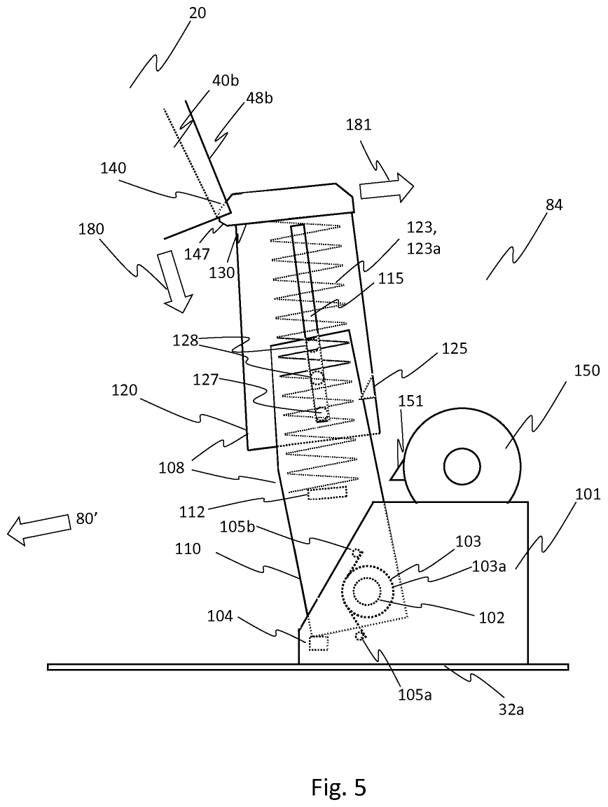

FIG. 5 shows a more detailed view of the moving end 84 of the battery holder 30 for a light electric vehicle 1. As discussed in conjunction with FIGS. 4a and 4b, battery holder 30 comprises a fixed end 80 and a moving end 84. The fixed end 80 comprises at least one pivot surface 81 arranged to provide a pivot to the battery 20 during the insertion and the detachment of the battery 20. The fixed end is not shown in FIG. 5, but however FIG. 5 shows a section of the battery 20 being inserted into the battery holder in the general direction of arrow 180.

The moving end 84 comprises a latch support 101, a locking unit 150 and a latch 108. Latch support 101 is arranged to provide support for the various units at the moving end 84. Locking unit 150 is connected to the latch support 101. Locking unit 150 is arranged to lock the moving end 84 (in particular the latch 108) when in a locked position and release the latch 108 when becoming unlocked and allowing the detachment or insertion of the battery 20.

The latch 108 comprises an axle 102 and an arm 110 arranged to rotate around the axle 102 and an extender 120 arranged to extend and contract the latch 108 telescopically in relation to the arm 110.

The concept “telescopically” means, for the purposes of this text, that the extender 120 is arranged to increase and decrease the length of the latch 108 by moving back and forth in relation to the arm 110 and in direction pointed by the direction of the arm 110.

In other words, for the purposes of this text, the concept “telescopically” or “telescopic” mean that the extender 120 is arranged to increase and decrease the length of the latch 108 by moving back and forth in relation to the arm 110 and in direction pointed by the direction of the arm 110.

Typical dictionary definition of the word “telescopic” is, for example, the ability “to be extended or retracted by the use of parts that slide over one another”.

Thus, the extender 120 may slide in relation to the arm 110 to provide a latch 108 such that the latch 108 may be telescopic.

In still other words, the extender 120 may comprise a portion that slides over the arm 110, or the arm 110 may comprise a portion that slides over the extender 120, such that the extender 120 may increase and decrease the length of the latch 108 by moving back and forth in relation to the arm 110, and move in direction pointed by the direction of the arm 110.

Thus, the extender 120 and the arm 110 may comprise one or more overlapping portions such that one or more portions of the extender 120 overlap one or more portions of the arm 110.

Alternatively, the extender 120 and the arm 110 may comprise one or more overlapping portions such that one or more portions of the arm 110 overlap one or more portions of the extender 120.

The direction pointed by the direction of the arm 110 is called a pointing direction of the arm 110.

The pointing direction of the arm 110 is determined by the rotation of the arm 110 around the axle 102.

The pointing direction of the arm 110 also determines the pointing direction of the latch 108, due to the telescopic movement of the extender 120 in relation to the arm 110.

Axle 102 is arranged to connect the arm 110 to the latch support 101 so that the arm 110 and latch 108 can rotate around the axle 102, said rotation supported firmly by the latch support 101. According to an embodiment, latch 108 of the battery holder 30 comprises a force unit 123 arranged between the arm 110 and the extender 120 to provide force to extend the extender 120 from the arm 110, and a torsion unit 103 arranged between the arm 110 and the latch support 101 to provide torsion to the arm 110 to rotate the arm 110 around the axle 102 towards the fixed end 80. Direction of the fixed end is shown with arrow 80′.

In other words, the latch 108 of the battery holder 30 comprises a force unit 123 arranged between the arm 110 and the extender 120 to provide force to extend the extender 120 from the arm 110 such that the latch 108 is extended.

Force unit 123 is a unit that can exert a force to the extender 120 that extends the length of the latch 108 by attempting to move the extender 120 away from the latch support 101. There are substantially three separate, static positions in the extender 120:
a) the moving end 84 is locked and thus the extender 120 cannot move and remains in the locked position,
b) the extension has reached the position of the maximum extension, in other words, the length of the latch 108 is as long as possible and the extender 120 is maximally extended, making the latch 108 as long as the one or more extension stoppers 127 allow, or
c) the weight of the units (mostly extender 120 and in particular the battery 20) counterbalances the lifting force of the force unit) when the battery is being held by the moving end 84 but not yet locked. Resting position of the extender 120 depends on whether the battery 20 is being inserted or detached upwards or downwards relative to the moving end 84 as the force of gravity especially to the battery 20 counters the detachment and promotes the insertion when the insertion takes place downwards (esp. relative to the second end 48b of the battery); similarly, gravity counters the insertion and promotes detachment when the insertion takes place upwards (esp. relative to the second end 48b of the battery).

The force of the force unit is arranged to move the extender 120 telescopically in relation to the arm 110 and to extend the latch 108, in particular the length of the latch 108. In an embodiment, as in FIG. 5, the force unit 123 comprises a compression spring 123a that contracts when the extender 120 is pressed towards the arm 110 making the latch 108 shorter and also stores energy in a form of elastic potential energy and releases energy when the spring is allowed to resume its neutral position, pushing the extender away from the arm 110 and making the latch 108 longer from the compressed position. The spring is connected to a compression spring support 112 at first spring end which is also the position of the maximal compression of the spring 123a. At second spring end, the spring 123a is connected to the extender 120, in FIG. 5 to the top part of the extender. The telescopic movement of the extender 120 is guided by a guiding groove 115 which is part of the extender 120 in the embodiment shown in FIG. 5. The arm 110 comprises guiding pins 128 that reach to the inside of the guiding groove 115. The guiding pin closest to the axle 102 is also an extension stopper 127 that stops the extender 120 from over-extending and fall off the other end of the arm 110 and away from the latch 108. Any unit that limits the extension of the latch 108 and stops the extender 120 to the position of maximal extension can be arranged as an extension stopper 127. The arm 110 can comprise one or more extension stoppers 127. In general, the force unit 123 may comprise a spring. The force unit 123 may comprise one or more compression springs 123a, e.g. two compression springs 123a or three compression springs 123a.

The force unit 123 can also comprise an elastic band where the elastic band is arranged to pull the extender 120 to extend the length of the latch 108 telescopically. The force unit 123 can also comprise a hydraulic unit, e.g. a hydraulic piston that exerts a force to the extender to make the extender move telescopically. Similarly, the force unit 123 may comprise a pneumatic unit that also acts as a piston to move the extender 120. Any combination of the different embodiments of force units 123 mentioned above is also possible.

In FIG. 5, in an embodiment, the torsion unit 103 comprises a torsion spring 103a arranged around the axle 102 around which the latch 108 is arranged to rotate. The torsion unit 103 is supported by spring bracket 105a in the latch support 101, and spring bracket 105b in the latch. In the projection of FIG. 5, the torsion unit 103 is arranged to rotate arm 110, and by the same token, the extender 120 and in general the latch 108 towards the fixed end 80 of the battery holder 30 as shown in FIGS. 4a and 4b. Direction to the fixed end is also shown with arrow 80′. In FIG. 5, this direction of rotation is a counter clockwise rotation. Torsion unit can comprise one or more torsion springs 103a, for example two torsion springs 103a or three torsion springs 103a. In general, the torsion unit may comprise a spring.

As an embodiment, the torsion unit 103 comprises a compression spring that exerts the torsion to the arm 110 and consequently to the latch 108 that pushes the arm towards the fixed end in a piston-like fashion (compression spring not shown in FIG. 5). Alternatively, as an embodiment, the torsion unit 103 comprises a tension spring that pulls the arm towards the fixed and, causing torsion due to the axle 102 in the latch support 101 end of the arm (tension spring not shown). Still as an embodiment, the torsion unit comprises an elastic band (not shown) pulling the arm 110 towards the fixed end, a hydraulic unit (not shown) exerting force to the arm 110 towards the fixed end, a pneumatic unit (not shown) exerting force to the arm 110 towards the fixed end. Any combination of the torsion unit alternatives described herein is also possible.

In an embodiment, as shown in FIG. 5, the latch support 101 comprises one or more rotation stoppers 104 that are arranged to limit the angle of rotation of the latch 108 towards the fixed end 80. In the extreme position of the rotation towards the fixed end 80 of the latch 108, part of the arm 110 of the latch rests on the one or more rotation stoppers 104 and is not able to rotate further. This state is shown in FIG. 5. Without the one or more rotation stoppers 104, the torsion unit would rotate the latch 108 substantially against the surface between the fixed end 80 and the moving end 84. This would not be advantageous for the operation of the battery holder 30.

FIG. 5 shows also a locking unit 150 that is arranged to lock the latch 108 in a locked position in which the latch is in a contracted state. Locking is achieved with a locking tongue 151 and a locking notch 125. Locking of the battery holder 30 and the moving end 84 will be presented extensively later in the present application.

Turning to the other end of the latch 108, as an embodiment shown in FIG. 5, the extender 120 comprises a latch tongue 130 arranged to hold the battery 20.

As shown in FIG. 5, the latch tongue 130 may be arranged to protrude from the extender 120 in a direction which is towards or substantially towards the fixed end 80.

As also shown in FIG. 5, the latch tongue 130 may be arranged to protrude from the extender 120 in a direction which is perpendicular or substantially perpendicular to the telescopic extension and contraction of the latch 108.

In other words, the latch tongue 130 may be arranged to protrude from the extender 120 in a direction which is perpendicular or substantially perpendicular to the pointing direction of the arm 110.

Thus, the latch tongue 130 may be arranged to protrude from the extender 120 in a direction which has an angle which is from 80 degrees to 100 degrees relative to the pointing direction of the arm 110, or more preferably from 85 degrees to 95 degrees relative to the pointing direction of the arm 110.

The telescopic extension and contraction of the latch 108 are caused by movement of the extender 120 in relation to the arm 110.

The latch tongue 130 may be a beak or a beak-like unit that is arranged to protrude from the extender 120.

In an embodiment, the latch tongue 130 comprises a distal chamfer 140 (distal as seen from the latch support 101) arranged to provide torsion to the latch 108 that turns the latch 108 away from the fixed end 80 when the battery 20 comes into contact with the latch 108 during the insertion of the battery 20. This state of insertion is shown in FIG. 5. Arrow 181 indicates the rotation of the latch away from the fixed end 80 when the second end of the battery 20 moves towards the moving end 84 of the battery holder (fixed end 80 not show in FIG. 5 but as shown in FIGS. 4a and 4b it is to the left of the moving end 84 in the projection of FIG. 5; this direction is shown with arrow 80′).

The latch tongue 130 comprises also a proximal chamfer 147 (proximal as seen from the latch support 101), which is arranged to aid in the release of the battery, described later in this application.

Latch tongue 130 may comprise a distal chamfer 140, a proximal chamfer 147, or both a distal chamfer 140 and a proximal chamfer 147.

In other words, the distal chamfer 140 is provided on a distal side of the latch tongue 130 relative to the latch support 101.

Similarly, the proximal chamfer 147 is provided on a proximal side of the latch tongue 130 relative to the latch support 101.

In the step of FIG. 5 where the insertion of the battery commences, the extender 120 does not yet move telescopically in relation to the arm 110. Instead, it rotates or swivels a bit away from the fixed end to give room for the battery to slide towards the moving and 84. This is shown with arrow 181. Thus, even though the movement of the battery 20 (its second end 48b) is towards the moving end 84, it does not yet press the extender 120 to compress the latch 108. Instead, the extender 120 and its latch tongue 130 slides along the surface of the second end of the battery, in particular along the surface of the grooved end cap 40b.

In an embodiment, latch support 101 is installed in a fixed way in a connecting element 32 of which portion 32a is shown. The connecting element is arranged to connect the fixed end 80 and the moving end 84 so that their distance and relative orientation is suitable for the battery insertion, holding and detachment. The connecting element 32 comprises a rail or a narrow sheet to which the fixed end 80 or the moving end 84 or both are affixed, or a portion of the frame 2 of the light electrical vehicle. In other words, the connecting element 32 can comprise a part of the vehicle frame 2.

The state of the latch 108 of the battery holder 30 in FIG. 5 is called the pre-insertion state. As already mentioned, this is the state where the insertion of the battery 20 commences. In the pre-insertion state, the extender 120 is pushed to a position of maximum free extension by the force unit 123. The arm 110 is pushed to a position of maximum rotation by the torsion unit 103, limited by one or more rotation stoppers 104. Arranging a pre-insertion state to the insertion process of the battery allows the battery 20 to be inserted into the battery holder 30 by using one hand only, as it is simple to hold the battery with one hand, place the first end of the battery and its notches against the fixed end, and then letting the edge of the second end, the grooved end cap 40b, come to contact with the distal chamfer 140 of the latch tongue 130 by rotating the battery 20 with by help of the pivot surface 81 at the fixed end 80.

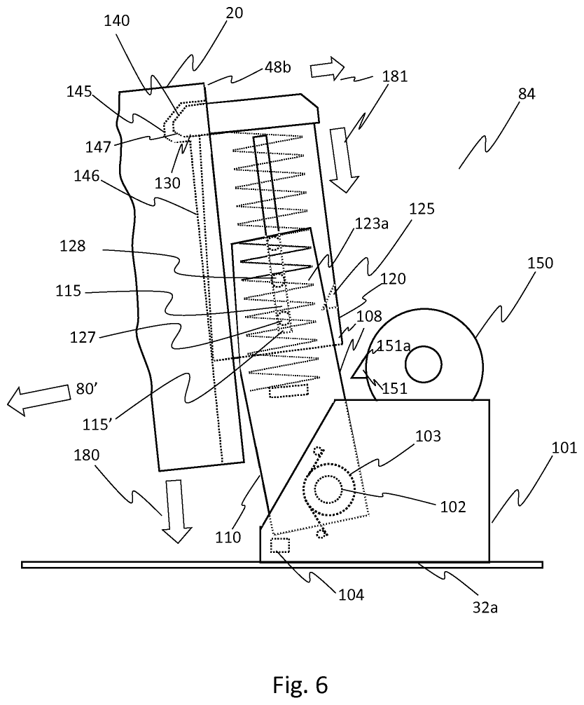

FIG. 6 shows the insertion state of the battery where the battery 20 is approximately half-way between the start of the insertion (shown in FIG. 5) and the last stage of the insertion (shown later), the attached state or locked state of the battery 20 and the locking of the battery holder 150. This state is called the pre-locking state. In the pre-locking state, the other end (that is, the second end 48b) of the battery 20 is moving in the general direction indicated by arrow 180. Before this state, during the insertion of the battery 20, the latch tongue 130 of the extender 120 of the latch 108 has slid into the notch 145 of the grooved end cap 40b of the battery 20, and the notch 145 presses the extender 120 (in the projection of FIG. 6) down by the tongue 130 of the latch 108 as the battery 20 rotates towards its attached state (which is also called the locked position or locked state). Battery 20 specifically rotates as it is held and pivoted by the fixed end, direction of which is shown by arrow 80′. In the case shown in FIG. 6 where the battery moves downwards during the insertion, in pre-locking state the force of the force unit 123 counterbalances the force of gravity exerted to the battery 20, and to move the battery 20 further, it needs to be pressed e.g. by hand. However, this can be managed with one hand only.

After the pre-locking state and as the insertion of the battery 20 goes forward, the extender 120 of the latch 108 moves slightly away from the fixed end and substantially towards the axle of rotation 102 of the arm 110 of the latch 108. These movements are indicated by the arrows 181. By the same token, the force unit 123, in this case the compression spring 123a gets loaded with elastic potential energy as the compression spring 123a compresses due to the movement of the extender 120 contracting the latch 108.

In the pre-locking state and during the further insertion of the battery 20, the latch tongue 130 is in the notch of the grooved end cap 40b of the battery 20 firmly as the torsion unit 103 generates torsion around the axle 102 and therefore presses the other side of the latch 108 against the grooved end cap 40b of the battery 20. Especially the latch tongue 130 of the extender 120 is pressed against the notch 145 in the groove 146 of the grooved end cap 40b.

In other words, the torsion unit 103 is arranged to generate torsion around axle 102 such that the latch 108 presses the battery 20 towards the fixed end 80 during the insertion of the battery 20 to the battery holder due to the torsion generated by the torsion unit 103.

FIG. 6 illustrates also that the extender 120 comprises a locking notch 125 and the locking unit 150 comprises a locking tongue 151 having an unlocked position where the locking tongue 151 is outside the locking notch 125 of the extender 120 of the latch 108. The locking tongue 151 is arranged to swivel towards the latch support 101 when the extender 120 travels towards the latch support 101, allowing the travel of the extender 120 and not blocking the travel in the direction of contracting and shortening the latch 108 telescopically. Also the chamfered shape 151a of the locking tongue 151 aids in the swiveling of the locking tongue 151.

FIG. 6 also illustrates that the extender 120 is arranged to extend and contract telescopically in relation to the arm 110 guided by at least one guiding groove 115 and at least one guiding pin 128. The projection of FIG. 6 hides the fact that there may be more than one guiding grooves 115, for example one at the other side of the extender 120. Similarly, there can be more guiding pins 128 for example at the other side of the arm 110. The same applies for extension stoppers 127.

Telescopic movement and telescopic contracting and expansion can be also achieved so that the extender 120 is arranged to extend and contract telescopically in relation to the arm 110 guided by the inner shape of the arm 110 and the matching outer shape of the extender 120. In this arrangement, the arm 110 slides telescopically around the extender 120 and the extender 120 slides in and out the arm 110. Further, in this configuration the cross section of the arm 110 can encircle the extender partially or completely. It is important to provide support for the telescopic movement so that the extender 120 does not “get derailed” from the arm 110. By the same token, alternatively the extender 120 is arranged to extend and contract telescopically in relation to the arm 110 guided by the or the outer shape of the arm 110 and the matching inner shape of the extender 120. In this embodiment, the arm slides inside the extender during contraction of the latch 108 and slides out of it during expansion. Also combinations of these embodiments are possible where, as a further embodiment, the extender 120 is arranged to extend and contract telescopically in relation to the arm 110 guided by at least one guiding groove 115 and at least one guiding pin 128, and the inner shape of the arm 110 and the matching outer shape of the extender 120, or at least one guiding groove 115 and at least one guiding pin 128, and the outer shape of the arm 110 and the matching inner shape of the extender 120.

Again, the movements shown in FIG. 6 can be provided with one hand by the operator of the vehicle as it is a simple matter of pushing the second end 48b of the battery 20 end towards the latch support 101.

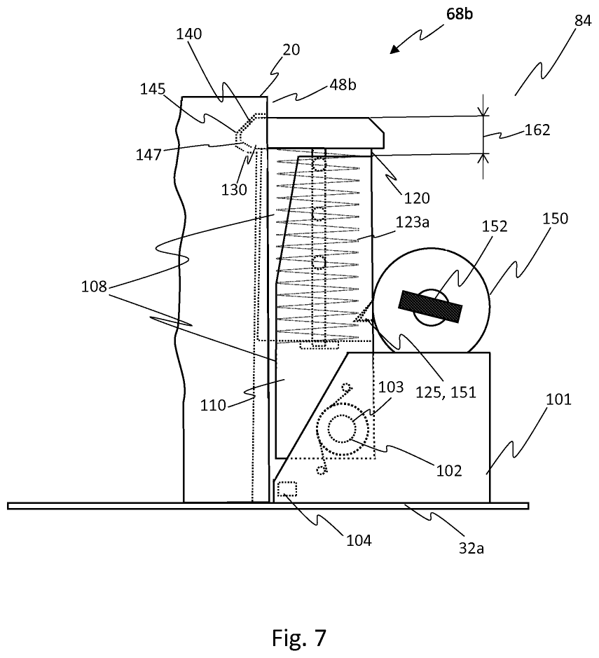

FIG. 7 shows the locked of the position (or locked state) 68b of the battery holder 30 holding the battery 20 firmly (again, only the second end 48b of the battery 20 is shown). The force unit, here the compression spring 123a is in the most compressed state storing the maximal elastic potential energy. In the locked position or locked state 68b, the distance 162 between the upper edge of the arm 110 and upper edge of the extender 120 is the shortest in the operation of the moving end 84. In other words, the latch 108 is at the shortest state as the extender 120 has moved in relation to the arm 110, contracting the latch 108 telescopically.

FIG. 7 illustrates, in particular, that the extender 120 comprises a locking notch 125 and the locking unit 150 comprises a locking tongue 151 having a locked position where the locking tongue 151 is in the locking notch 125 of the extender 120 of the latch 108 to hold the latch 108 in a locked position. In the locked position, the latch 108 cannot move towards the fixed end by rotating around axle 102 as the battery 20 is blocking this rotational movement. Until becoming unlocked, the locking unit 150 also keeps the extender in the locked position and removal of the battery 20 from the battery holder 30 is not possible, preventing both theft of the battery 20 and the unwanted slippage out of the battery holder 30.

There are various options for a locking unit of the battery holder 30. In an embodiment, the locking unit 150 comprises a lock operable with a key 152. Alternatively, in a simpler embodiment, the locking unit can comprise a bolt that holds the locking unit in different positions by fastening the locking unit with a bolt, attached to threads corresponding to various positions of the locking unit (bolt and threads not shown). Alternatively, the locking unit can comprise a clamp that presses the locking unit to hold it steady in various positions. Of course, a key/lock combination is effective against theft.

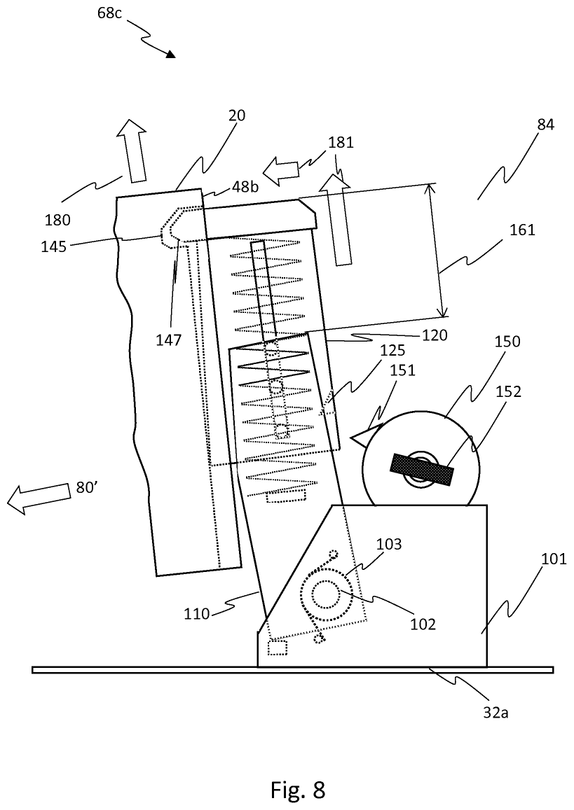

FIG. 8 illustrates the unlocking and the detachment of the battery 20 from the battery holder 30. In an embodiment of the present invention, when the locking unit 150 becomes unlocked with a battery 20 in an attached state in the battery holder 30, the force unit 123, here a compression spring 123a, is arranged to push the extender 120 to a distance of maximum loaded extension 161, whereby the battery 20 rotates about the pivot surface 81 (pivot surface 81 shown in FIGS. 4a and 4b and the direction of its location is shown by arrow 80′) by a force exerted to the battery 20 with the latch tongue 130 of the extender 120, and after the rotation, latch tongue 130 is arranged to hold the battery 20 in a pre-release state by the torsion of the torsion unit 103 of the latch 108.

In the projection of FIG. 8, the locking tongue 151 has rotated clockwise, enabling the release of the extender 120 which expands the latch 108 telescopically and, by the same token, rotates (in FIG. 8, mostly lifts) the battery's second end in the direction of arrow 180 away from the latch support 101. The movement of the battery 20 is essentially rotational as it occurs supported by the pivot surface 81 supporting the first end of the battery 20, pivot surface 81 being essentially the center of rotation. Again, the torsion unit 103 generates torsion such that the latch tongue 130 does not detach from the notch 145 during the rotation set in motion by the release of the elastic potential energy of the compression spring 123a. Owing to the elastic energy in the compression spring 123a, the movement in FIG. 8 happens with no other user intervention than the unlocking (or otherwise releasing) the locking unit 150.

In other words, the torsion unit 103 is arranged to generate torsion around axle 102 such that the latch 108 presses the battery 20 towards the fixed end 80 during the detachment of the battery 20 from the battery holder due to the torsion generated by the torsion unit 103.

Depending on the orientation of the installation of the battery holder, in an embodiment, it is advantageous to arrange the torsion unit 103 to generate torsion of magnitude that maintains the pre-release state and holds the battery 20 also when the battery 20 rotates downwards (esp. when seen from the second end 48b) from the attached state to the pre-release state. In other words, in this case, when the vehicle is in a normal operating position, the second end 48b of the battery 20 rotates downwards and the entire battery 20 is pulled away from the battery holder by gravity. If the torsion of the torsion unit 103 is weak, the battery slips out of the grasp of the latch 108 and falls down. However, e.g. with a suitably strong torsion unit 103, e.g. a strong torsion spring or two or three torsion springs, the extender 120 of the latch 108 can exert a suitable force to the battery 20 that pushes it against the fixed end (direction of which is marked with arrow 80′) so that the battery 20 does not fall off even when detached downwards. If the battery is detached upwards (that is, its second end rotates upwards when released from the attached state), the gravity cannot pull the battery away from the battery holder 30 as gravity in this case pulls the battery 20 back towards the attached position.

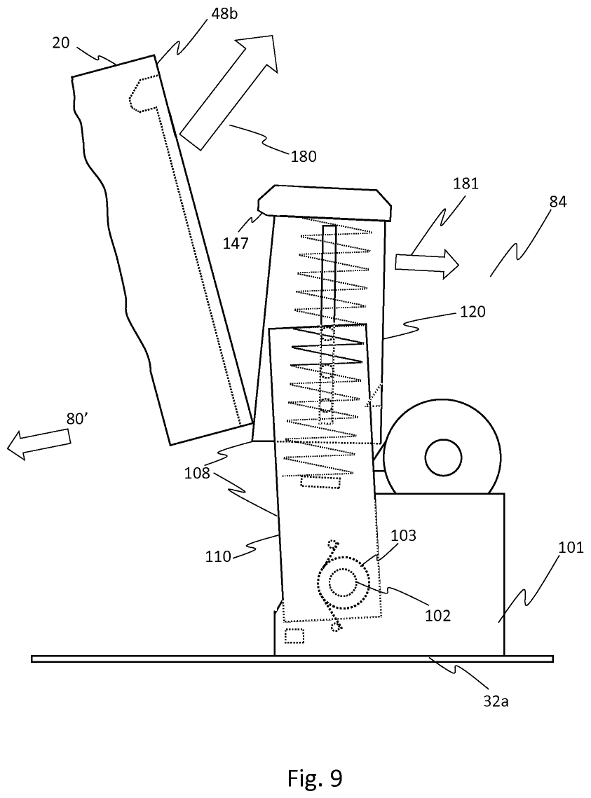

FIG. 9 shows finally how the battery 20 can be taken completely out of the battery holder 30 according to the invention. By pulling the battery 20 out and against the latch 108, the latch 108 is arranged to give in a bit by rotating around an axle 102, in the direction of the arrow 181 and against the torsion generated by the torsion unit, away from the fixed end which resides in the direction of the arrow 80′. The movement of the latch 108 away from the fixed end is also caused by the proximal chamfer 147 in the latch tongue 130. Proximal chamfer 147 is arranged to create a rotation to the latch 108 around the axle 102 from the pulling of the battery 20 away from the battery holder 30 and its moving end 84. In other words, the latch tongue 130 comprises a proximal chamfer 147, and the proximal chamfer 147 is arranged to provide torsion to the latch 108 that turns the latch 108 away from the fixed end when the battery 20 is being detached from the battery holder 30.

By pulling the battery's second end against the latch 108, it comes separated from the fixed end at the first end of the battery 20 so that the battery can be completely removed. This is because the protrusions of the fixed end get, due to the suitably long pulling motion of the battery 20, out of the notches at the first end cap 40a. Again, the pulling motion in FIG. 9 can easily be made with one hand only, especially as the proximal chamfer 147 also aids in rotating the latch 108 away from the fixed end, the direction of the location of which is shown with arrow 80′.

As a further aspect of the invention, referring back to FIG. 4a, the present application discloses a battery holder arrangement. In the arrangement, the battery holder is the battery holder defined above in the present application. The battery holder arrangement comprises further a battery 20, and the battery 20 comprises a first end cap 40a. The first end cap 40a comprises at least one notch 42 into which at least one pivot surface 81 of the battery holder 30 fits. The battery 20 rotates around the at least one pivot surface 81 during insertion of the battery 20 to the battery holder 30, and during detachment of the battery 20 from the battery holder 30.

In other words, the present application discloses a battery holder arrangement. The battery holder arrangement comprises a battery holder as defined above in the battery holder aspect and its embodiments and features. The battery holder arrangement comprises also a battery as defined in conjunction with the battery holder above. The battery comprises a first end cap, the first end cap comprising at least one notch into which at least one pivot surface of the battery holder fits, and the battery rotates around the at least one pivot surface during insertion of the battery to the battery holder, and during detachment of the battery from the battery holder.

The invention has been described above with reference to the examples shown in the figures. However, the invention is in no way restricted to the above examples but may vary within the scope of the claims.

1-13. (canceled)

14. A battery holder for a light electric vehicle, the battery holder comprising a fixed end and a moving end, the fixed end comprising at least one pivot surface arranged to provide a pivot to a battery during insertion and detachment of the battery, wherein:
the moving end comprises a latch support, a locking unit and a latch, the latch comprising:
an axle, and an arm arranged to rotate around the axle, and
an extender arranged to extend and contract the latch telescopically in relation to the arm, the extender comprising a latch tongue arranged to hold the battery, the latch comprising:
a force unit arranged between the arm and the extender, the force unit arranged to provide force to extend the extender from the arm, and
a torsion unit arranged between the arm and the latch support, the torsion unit arranged to provide torsion to the arm to rotate the arm around the axle towards the fixed end.

15. The battery holder according to claim 14, wherein:
the force unit comprises a compression spring, a tension spring, an elastic band, a hydraulic unit, a pneumatic unit, or any combination thereof.

16. The battery holder according to claim 14, wherein:
the torsion unit comprises a torsion spring, a compression spring, a tension spring, an elastic band, a hydraulic unit, a pneumatic unit, or any combination thereof.

17. The battery holder according to claim 14, wherein the latch tongue comprises:
a distal chamfer arranged to provide torsion to the latch, turning the latch away from the fixed end when the battery comes into contact with the latch during the insertion of the battery; or
a proximal chamfer arranged to provide torsion to the latch, turning the latch away from the fixed end when the battery is being detached from the battery holder; or
both a distal chamfer arranged to provide torsion to the latch turning the latch away from the fixed end when the battery comes into contact with the latch during the insertion of the battery, and a proximal chamfer arranged to provide torsion to the latch turning the latch away from the fixed end when the battery is being detached from the battery holder.

18. The battery holder according to claim 14, wherein the latch support comprises one or more rotation stoppers that are arranged to limit the angle of rotation of the latch towards the fixed end.

19. The battery holder according to claim 14, wherein the extender comprises a locking notch and the locking unit comprises a locking tongue having:
a locked position where the locking tongue is in the locking notch of the extender of the latch to hold the latch in a locked position, and
an unlocked position where the locking tongue is outside the locking notch of the extender of the latch.

20. The battery holder according to claim 14, wherein the locking unit comprises a lock operable with a key, a bolt or a clamp.

21. The battery holder according to claim 14, wherein the extender is arranged to extend and contract telescopically in relation to the arm guided by:
at least one guiding groove and at least one guiding pin; or
the inner shape of the arm and the matching outer shape of the extender; or
the outer shape of the arm and the matching inner shape of the extender; or
at least one guiding groove and at least one guiding pin, and the inner shape of the arm and the matching outer shape of the extender; or
at least one guiding groove and at least one guiding pin, and the outer shape of the arm and the matching inner shape of the extender.

22. The battery holder according to claim 14, wherein the battery holder further comprises a connecting element arranged to connect the fixed end and the moving end, the connecting element comprising:
a rail or a narrow sheet to which the fixed end or the moving end or both are affixed; or
a portion of the frame of the light electrical vehicle.

23. The battery holder according to claim 18, wherein when the insertion of the battery commences, the latch is arranged to be in a pre-insertion state in which:
the extender is pushed to a position of maximum free extension by the force unit, and
the arm is pushed to a position of maximum rotation by the torsion unit limited by the one or more rotation stoppers.

24. The battery holder according to claim 14, wherein when the locking unit becomes unlocked with the battery in an attached state in the battery holder,
a) the force unit is arranged to push the extender to a distance of maximum loaded extension, whereby the battery rotates about the pivot surface by a force exerted to the battery with the latch tongue of the extender, and
b) after the rotation, the latch tongue is arranged to hold the battery in a pre-release state by torsion of the torsion unit of the latch.

25. The battery holder according to claim 24, wherein the torsion unit is arranged to generate torsion of magnitude that maintains the pre-release state and holds the battery when the battery rotates downwards from the attached state to the pre-release state.

26. The battery holder arrangement, wherein:
the battery holder of the battery holder arrangement is a battery holder as defined in claim 14,
the battery holder arrangement comprises a battery, the battery comprising a first end cap, the first end cap comprising at least one notch into which at least one pivot surface of the battery holder fits, and
the battery rotates around the at least one pivot surface during insertion of the battery to the battery holder, and during detachment of the battery from the battery holder.
